(19) United States
(12) Patent Application Publication
(10) Pub. No.: US 2014/0223504 A1
(43) Pub. Date: Aug. 7, 2014

(54) CABLE DISTRIBUTION NETWORKS

(71) Applicant: MaxLinear, In., Carlsbad, CA (US)

(72) Inventors: Curtis Ling, Carlsbad, CA (US); Timothy Gallagher, Encinitas, CA (US); Gopalan Krishnamurthy, Carlsbad, CA (US)

(73) Assignee: MaxLinear, In., Carlsbad, CA (US)

(21) Appl. No.: 14/175,143

(22) Filed: Feb. 7, 2014

Related U.S. Application Data
(60) Provisional application No. 61/762,276, filed on Feb. 7, 2013.

(51) Int. Cl. H04N 21/61; H04N 21/23

(52) U.S. Cl. CPC H04N 21/6168; H04N 21/23
USPC 725/116

(57) ABSTRACT

Methods and systems are provided for cable distribution networks, in which a headend may generate one or more downstream signals for communication in a distribution network associated with the headend. The generating of the one or more downstream signals may comprise combining data and/or video for one or more service groups, from signals corresponding to a plurality of services, with the combining being performed in digital domain. The distribution network comprises a cable distribution network, such as a hybrid fiber-coaxial (HFC) based network. The plurality of services comprises cable television (e.g., DOCSIS) services, VOD services, SDV services, OOB services, and/or broadcast television services. The headend may control feedback from the distribution network, and may control the combining performed therein based on the received control feedback. The control feedback may be received from, for example, fiber nodes and/or user equipment in the distribution network.

### CLAIM OF PRIORITY

This patent application makes reference to, claims priority to and claims benefit from the U.S. Provisional Patent Application No. 61/762,276, filed on Feb. 7, 2013, which is hereby incorporated herein by reference in its entirety.

### INCORPORATION BY REFERENCE

This patent application makes reference to U.S. Provisional Patent Application Ser. No. 61/596,291 filed on Feb. 8, 2012 and U.S. Provisional Patent Application Ser. No. 61/620,746 filed on Apr. 5, 2012.

Each of the above-identified applications is hereby incorporated herein by reference in its entirety.

### TECHNICAL FIELD

Aspects of the present application relate to communications. More specifically, certain implementations of the present disclosure relate to methods and systems for cable distribution networks.

### BACKGROUND

Existing methods and systems for cable distribution networks may be overly inefficient, slow, expensive, and/or high-maintenance. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for cable distribution networks, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF THE DRAWINGS

FIG. 1 illustrates an example cable distribution setup.

FIG. 2 illustrates an example headend architecture that is configured to combine signals in the analog domain.

FIG. 3 illustrates an example headend architecture that is configured to combine signals in the digital domain.

FIG. 4 illustrates an example headend that is configured to combine signals in the digital domain, with backward compatibility support of analog domain based combining.

FIG. 5 illustrates example cable network topology.

FIG. 6 is a flowchart illustrating an example process for combining content from different services into multiple service groups for downstream distribution.

### DETAILED DESCRIPTION

Certain example implementations may be found in method and system for non-intrusive noise cancellation in electronic devices, particularly in user-supported devices. As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

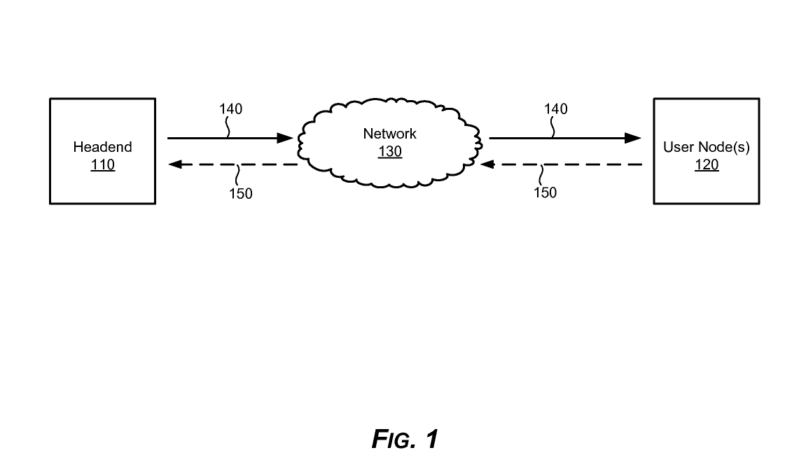

FIG. 1 illustrates an example cable distribution setup. Referring to FIG. 1, there is shown a communication system 100 comprising a headend 110, a user node 120, and a network 130.

The communication system 100 may comprise a plurality of devices (of which the headend 110 and the user node 120 are shown), and communication resources (of which the network 130 is shown) to enable the devices to communicate with one another, such as via the network 130. The communication system 100 may correspond to a distribution system, which may be used in distributing content and other data. In this regard, the communication system 100 may correspond to a cable distribution network.

The headend 110 may comprise suitable circuitry for performing headend related functions in distribution systems. In this regard, the headend 110 may serve as a master node, being configured for receiving signals (e.g., television signals or other media based signals) from one or more sources, for processing and distribution over a particular distribution system (e.g., a cable distribution system).

The user node 120 may comprise suitable circuitry for performing user-end related functions in distribution systems. For example, the user node 120 may correspond to customer premise equipment (CPE) in a cable distribution system (e.g., DOCSIS modems and/or television set-top boxes).

The network 130 may comprise a system of interconnected resources (hardware and/or software), for facilitating exchange and/or forwarding of data (including, e.g., such functions as routing, switching, and the like) among a plurality of nodes (e.g., one or more headends and/or one or more user nodes), based on one or more networking standards. Physical connectivity within, and/or to or from the network 130, may be provided using, for example, copper wires, fiber-optic cables, wireless links, and the like. In instances where the communication system 100 may be a cable distribution system, the network 130 may correspond to coaxial based network, a fiber-optic based network, or a hybrid fibre-coaxial (HFC) based network.

In operation, the communication system 100 may be used as a distribution system, for enabling distribution of data (e.g., media content) to a plurality of end-users (e.g., the user nodes 120). In this regard, the headend 110 may be configured to receive signals (e.g., television signals or other media based signals) from one or more sources, and process the signals for distribution via communication system 100. The processing may comprise generating downstream signals 140, configured in accordance with the interface(s) and/or standard(s) used within the communication system 100, for communication to the user nodes 120. For example, in instances where the communication system 100 may be a cable distribution system, the headend 110 may generate the downstream signals 140 particularly for communication and/or distribution over coaxial, fiber, or HFC based interconnects. Further, in some instances, the communication system 100 may be configured to support upstream communications. In this regard, the user nodes 120 may be operable to generate (and the headend 110 may be operable to receive and handle) upstream signals 150. The upstream signals 150 may be used, for example, to convey data (e.g., user generated content), user inputs/commands (e.g., requests for particular content), control data (e.g., status, errors, etc.), and the like.

In some instances, the communication system 100 may be configured to support handling a plurality of heterogeneous services. For example, the headend 110 may support several heterogeneous services, such as cable based services (e.g., DOCSIS), video on demand (VOD), switched digital video (SDV), out-of-band control signals (OOB), and/or broadcast analog and/or digital television. Accordingly, the headend 110 may be operable to combine the several heterogeneous services (that is content or data corresponding to the services) into the downstream signals 140 communicated to the user nodes 120. In various implementations in accordance with the present disclosure, the communication system 100 may be configured to optimize distribution operations, such as by optimizing the combining of signals corresponding to different heterogeneous services. This may be achieved by incorporating optimized headend architectures, as described with reference to at least some of the following figures.

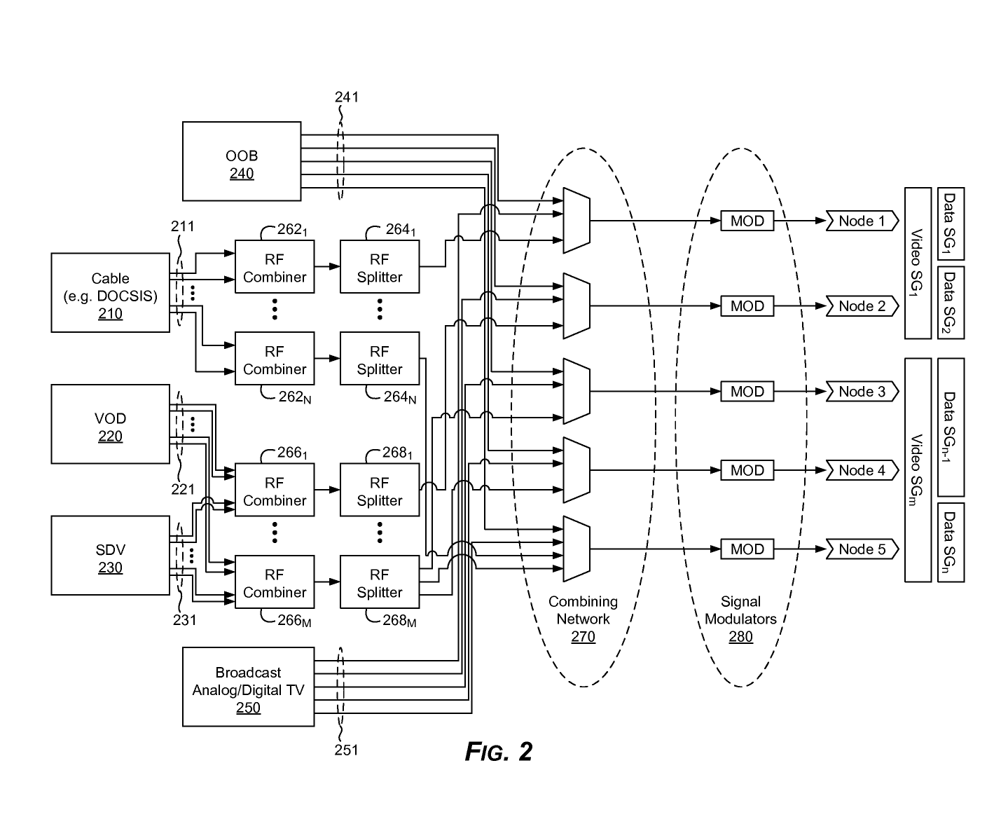

FIG. 2 illustrates an example headend architecture that is configured to combine signals in the analog domain. Referring to FIG. 2, there is shown headend architecture 200.

The headend architecture 200 may comprise suitable circuitry for supporting headend operations and/or functions. The headend architecture 200, as depicted in FIG. 2, may support several heterogeneous services, such as cable based services (e.g., DOCSIS), video on demand (VOD), switched digital video (SDV), out-of-band control signals (OOB), and/or broadcast analog and/or digital television. Accordingly, the headend architecture 200 may be operable to combine the several heterogeneous services, for communication to end-user (e.g., customer premises) equipment, such as DOCSIS modems and/or cable television set-top boxes. The communication may be done, for example, via a hybrid fiber coaxial (HFC) plant.

The headend architecture 200 may correspond to legacy headend architectures, in which analog devices (e.g., RF combiners, RF splitters, and the like) may be used for combining data corresponding to the heterogeneous services onto communication signals (e.g., HFC based signals). In other words, in headend architectures such as the headend architecture 200, feeds from the heterogeneous services may be combined in the analog domain, using hard cabling and suitable analog devices and/or components.

For example, in the implementation depicted in FIG. 2, the headend architecture 200 may comprise a plurality of RF combiners 262₁-262_{N} and a corresponding plurality of RF splitters 264₁-264_{N}, for use in combining cable data (e.g. DOCSIS) downstreams. In this regard, DOCSIS data downstream 211, obtained via cable downstream interface 210 (e.g., network interface) may be combined via the RF combiners 262₁-262_{N} and the RF splitters 264₁-264_{N}. Each of the RF combiners 262₁-262_{N} may be configured, e.g., for combining one or more of the DOCSIS data downstream 211 onto a particular service group (e.g., one of a plurality of data service groups: SG₁-SGₙ, supported via the headend architecture 200), to generate a corresponding combined datastream. Each combined datastream may then output by a corresponding one of the RF splitters 264₁-264_{N} into a passive combining network 270. The passive combining network 270 may comprise a plurality of combining elements (e.g., 8 way combiners), arranged in branches (i.e., as parallel paths). In this regard, each of the combining elements in the passive combining network 270 may correspond to a particular communication signal—e.g., corresponding to particular one of available HFC transmitter nodes, and as such each of the combining elements in the passive combining network 270 may feed a corresponding optical transmitter node (e.g., one of nodes 1-5). Each of the RF splitters 264₁-264_{N} outputs video stream handled thereby onto one or more branches of the passive combining network 270, corresponding to the video service group associated with the particular RF splitter. In this regard, determining to which of the branches of the passive combining network 270 corresponding to the service group each of the RF splitters 264₁-264_{N} is coupled is based on predetermined service group mapping. For example, RF splitter 264₁ only outputs to the first branch of the passive combining network 270, since data SG₁ is mapped onto transmitter node 1, whereas RF splitter 264_{N-1} (not shown) outputs to both of the third and fourth branches of the passive combining network 270, since data SGₙ₋₁ (as shown in the example depicted in FIG. 2) is mapped onto transmitter nodes 3 and 4.

Combining video downstreams may be done in a substantially similar manner. For example, in the implementation depicted in FIG. 2, the headend architecture 200 may comprise a plurality of RF combiners 266₁-266_{M} and a corresponding plurality of RF splitters 268₁-268_{M}, for use in combining video downstreams (e.g., VOD and SDV streams). In this regard, downstream VOD streams 221 and downstream SDV streams 231 (obtained via VOD interface 220 and SDV interface 230, respectively) may be combined via the RF combiners 266₁-266_{M} and the RF splitters 268₁-268_{M}. Each of the RF combiners 266₁-266_{N} may be configured, e.g., for combining one or more VOD and/or SDV video streams onto a particular service group (e.g., one of a plurality of video service groups: SG₁-SGₘ, supported via the headend architecture 200), to generate a corresponding combined video stream. Each combined video stream may then be output by a corresponding one of the RF splitters 268₁-268_{M} into the passive combining network 270. In this regard, each of the RF splitters 268₁-268_{M} outputs video stream handled thereby onto one or more branches of the passive combining network 270, corresponding to the video service group associated with the particular RF splitter. Determining to which of the branches of the passive combining network 270 each of the RF splitters 268₁-268_{M} is coupled is based on predetermined service group mapping. For example, RF splitter 268ₘ outputs to the third, fourth and fifth branches of the passive combining network 270, since video SGₘ (as shown in the example depicted in FIG. 2) is mapped onto transmitter nodes 3, 4 and 5.

Further, the passive combining network 270 may combine with the outputs of the RF splitters 264₁-264_{N} and the outputs of the RF splitters 268₁-268_{M}, other signals such as OOB downstream signals 241 (obtained via an OOB interface 240, e.g., a network interface) and/or television broadcast (digital and/or analog) downstream signals 251 (obtained via a broadcast television interface 250, e.g., a network interface). Accordingly, the outputs of the RF splitters 264₁-264_{N} (i.e., cable data downstreams), the outputs of the RF splitters 268₁-268_{M} (i.e., video downstreams), the OOB signals 241, and the broadcast television signals 251 are combined in the analog/RF domain via the passive combining network 270. Thus, the outputs of the passive combining network 270 may be processed (e.g., digital processing) for communication over the utilized interface (in accordance with the utilized protocol). For example, outputs of the branches of the passive combining network 270 may be conveyed (e.g., via coaxial cable) to a corresponding one (or ones) of the one or more signal modulators 280 (e.g., laser modulator in HFC setups), for generating corresponding communication signals (e.g., HFC based signals).

The headend architecture 200, as described herein, may incorporate a relatively large amount of cabling and RF/analog devices for use in service group mapping and combining of a multitude of data and video streams for distribution via the HFC plant. The use of such extensive cabling and RF/analog devices however, may be undesirable, as it may result in substantial power dissipation, and further demand that the modulators drive the combiners 262₁-262_{N} and 266₁-266_{M} at a very high output power. Consequently, the port density of the modulators may be low due to the need for heat sinks and/or other thermal management measures. Management/maintenance of the headend in FIG. 2 may be costly because, for example, power/level differences caused by different output powers of the various modulators and/or caused by non-idealities in the analog/RF network (combiners, splitters, cabling, etc.) may need to be leveled using manually-tuned attenuators. Additionally, the use of the cables and the RF/analog components may be inflexible due to the components' hard-wired nature, bulkiness, reliability issues, and/or possible increased maintenance/management costs.

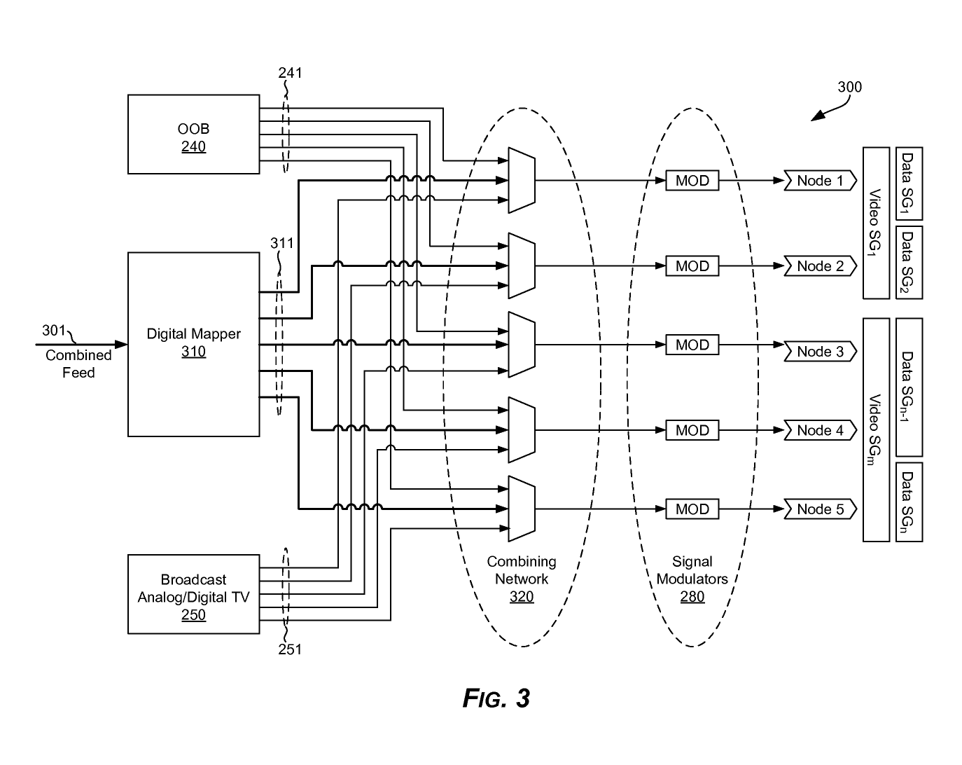

FIG. 3 illustrates an example headend architecture that is configured to combine signals in the digital domain. Referring to FIG. 3, there is shown headend architecture 300.

The headend architecture 300 may comprise suitable circuitry for supporting headend operations and/or functions. In this regard, the headend architecture 300 may be substantially similar to, for example, the headend architecture 200, as described with respect to FIG. 2, and accordingly may similarly support several heterogeneous services, such as cable (e.g., DOCSIS), VOD, SDV, OOB, and/or broadcast analog and/or digital television based services, and as such may be configured to combine signals from the different services for communication to end-user (e.g., customer premise) equipment, such as via an HFC based distribution network. Nonetheless, the headend architecture 300 may be implemented in a manner that may obviate the need for the extensive wiring used, and/or the RF/analog based combining done, in the headend architecture 200.

In particular, rather than combining signals (e.g., data and/or video) corresponding to feeds from the heterogeneous services in the analog domain, the headend architecture 300 may be configured to perform the combining in the digital domain (close to the point of reception of the feeds), thus obviating the need for the RF/analog devices/components (e.g., the RF combiners/splitters), and the wiring needed to input/output to/from the RF/analog devices/components. For example, in the example implementation depicted in FIG. 3, the headend architecture 300 may comprise a digital mapper 310, a passive combining network 320, and the signal modulators 280 of FIG. 2.

The digital mapper 310 may comprise suitable circuitry for obtaining data and/or video corresponding to plurality of different type of feeds, and map data and/or video obtained therefrom onto corresponding data and/or video service groups. For example, the digital mapper 310 may be operable to receive (e.g., over a network interface) a combined feed 301, which comprises data/video corresponding cable (e.g., DOCSIS), VOD, and SDV. In this regard, the digital mapper 310 may provide the interfacing functions performed by the cable interface 210, the VOD interface 220, and the SDV 230 of FIG. 2. Further, the digital mapper 310 may be operable to map data and/or video obtained from the combined feed 301 (i.e. data corresponding to DOCSIS downstreams and video corresponding to VOD and/or SDV downstreams) into combined downstreams corresponding to a plurality of service groups (e.g., the data SG₁-SGₙ and the video SG₁-SGₘ of FIG. 2). The mapping performed in the digital mapper 310, however, may be performed in the digital domain—i.e., may be done by means of data manipulation, without the need for hard wiring and/or RF combining/splitting. Analog signals, corresponding to the already mapped/combined data/video, may then be generated in the digital mapper 310, and outputted (via plurality of RF ports) as a plurality of outputs 311. Accordingly, because the mapping and combining is done digitally, with RF signals being generated afterwards, the use of digital mapper 310 may obviate the need for use of the RF combiners 262₁-262_{N}, the RF splitter 264₁-264_{N}, the RF combiners 266₁-266_{M}, and the RF splitters 268₁-268_{M} of FIG. 2.

The outputs 311 of the digital mapper 310 are fed into the passive combining network 320. In this regard, the passive combining network 320 may be substantially similar to, for example, the passive combining network 270 of FIG. 2 (e.g., also comprising a plurality of combining elements, such as 8 way combiners). Nonetheless, the passive combining network 320 may be configured to account for the fact that the outputs 311 (of the digital mapper 310) which are fed thereto are already combined in the digital mapper 310—i.e., each RF port in the digital mapper 310 feeds only one of the combining elements in the passive combining network 320.

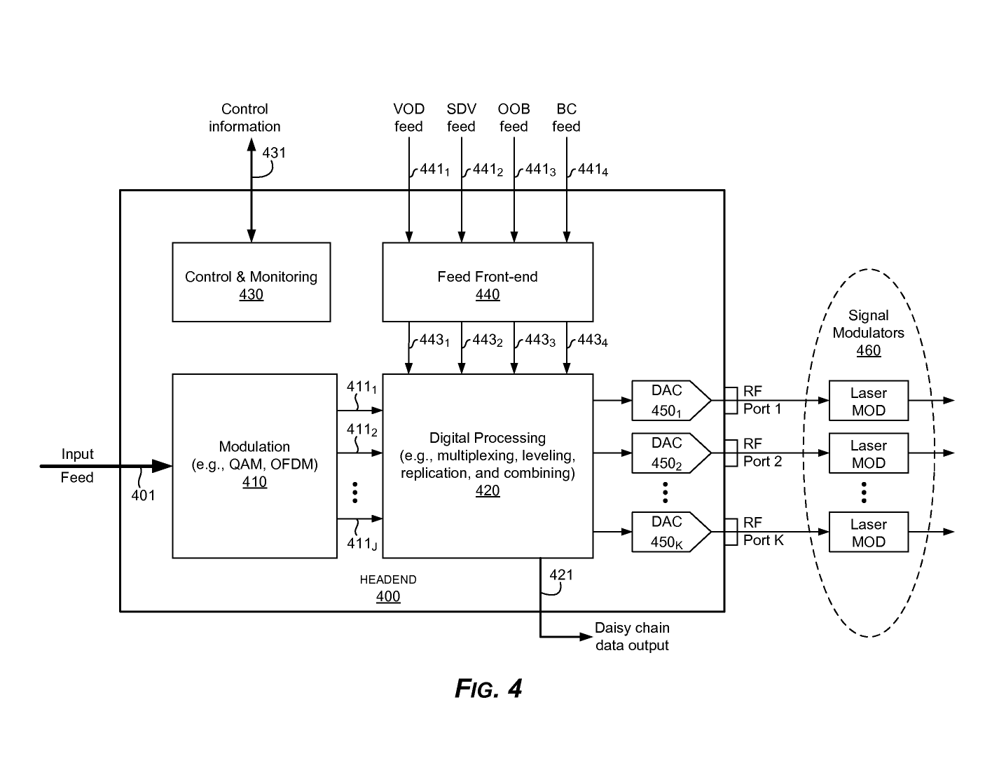

FIG. 4 illustrates an example headend that is configured to combine signals in the digital domain, with backward compatibility support of analog domain based combining. Referring to FIG. 4, there is shown headend 400.

The headend 400 may comprise suitable circuitry for supporting headend operations and/or functions. In particular, the headend 400 may be configured for supporting several heterogeneous services, such as cable (e.g., DOCSIS), VOD, SDV, OOB, and/or broadcast analog and/or digital television based services, and for generating signals combining content (e.g., video or other data) from the different services, for communication (e.g., via an HFC based distribution network) to end-user equipment. Further, the headend 400 may be implemented in a manner that may obviate the need for the extensive wiring used, and/or the RF/analog based combining done, in legacy headend architectures, such as by designing and/or configuring the headend 400 for combining signals in the digital domain. In this regard, the headend 400 may correspond to at least a portion of the headend architecture 300 of FIG. 3, for example. Further, the headend 400 may also incorporate, in some implementations, circuitry for supporting backward compatibility with legacy systems.

For example, as shown in the example implementation depicted in FIG. 4, the headend 400 may comprise a modulation circuit 410, a digital processing circuit 420, a control and monitoring circuit 430, a feed front-end circuit 440, one or more digital-to-analog converter (DAC) circuits 450₁-450_{K}, and one or more signal modulators 460.

The modulation circuit 410 may be operable to perform modulation and/or demodulation related operations. In particular, modulation circuit 410 may be configured to support modulation/demodulation required for handling signals, corresponding to one or more support services. For example, the modulation circuit 410 may comprise QAM, OFDM, and/or any other type of modulators which may be used to modulate signals in accordance with any one or more specified standard(s)/protocol(s) pertaining to any one or more supported services such as, for example, DOCSIS, SDV, VOD, and/or any other service used in television and/or data distribution networks. The signals handled by the modulation circuit 410 may be obtained from an input feed 401. In this regard, the modulation circuit 410 may be operable to receive the input feed 401 via a network interface, for example. Accordingly, in some instances, the input feed 401 may comprise a combined feed (e.g., similar to the combined feed 301 of FIG. 3), in which signals corresponding to multiple services (e.g., DOCSIS, SDV, and VOD) may be combined. The modulation circuit 410 may generate one or more outputs 411ᵢ, which may be conveyed to the digital processing circuit 420.

The feed front-end circuit 440 may be operable to receive and digitize one or more feeds, corresponding to one or more services, and may be operable to do so concurrently. For example, the feed front-end circuit 440 may be implemented as full-spectrum capture (FSC) front-end circuit, configured to concurrently digitize the full-spectrum of one or more feed signals 441ᵢ, provided as part of one or more services—e.g., broadcast analog/digital television service, VOD service, SDV service, OOB service, etc. In this regard, the feed front-end circuit 440 may concurrently digitize the most or all of the spectrum (corresponding to most or all available broadcast channels) of one or more broadcast television signals 441₄, the entire (or most of) spectrum of one or more VOD signals 441₁, the entire (or most of) spectrum of one or more SDV signals 441₂, and/or the entire (or most of) spectrum of one or more OOB channels 441₃.

The feed front-end circuit 440 may generate one or more digitized outputs 443ᵢ, which may be conveyed to the digital processing circuit 420. For example, when used to receive and digitize feed signals 441₁-441₄ (corresponding to VOD, SDV, OOB, and broadcast feeds), the feed front-end circuit 440 may generate corresponding digitized outputs 443₁-443₄, as shown in FIG. 4. Further, the feed front-end circuit 440 may render the original source of the outputs 443ᵢ transparent within the headend 400. Thus, the headend 400 as described in FIG. 4 may be used in a substantially similar manner to one of the architectures shown in FIG. 2 or 3. Accordingly, in an example implementation, the feed signals 441₁-441₄ received by the feed front-end circuit 440 may correspond to (i.e., be the same signals as) signals 221, 231, 241, and/or 251 shown in FIGS. 2 and/or 3. In an example implementation, the signals 311 in FIG. 3 may be the analog version of at least some of the signals 411ᵢ (e.g., signals 441₁ and 441₂) shown in FIG. 4.

In an example implementation, the feed front-end circuit 440 may comprise an analog-to-digital converter (ADC) for each input 441ᵢ (e.g., 4 ADCs, for each of the feed signals 441₁-441₄). In such an example implementation, each of the analog-to-digital converters may be configured as described in, for example, U.S. patent application Ser. No. 13/485,003 and/or U.S. patent application Ser. No. 13/336,451, each of which is hereby incorporated herein by reference in its entirety.

The control and monitoring circuit 430 may be operable to communicate control information 431, which may be exchanged with (i.e., communicated to and/or from) one or more control terminals (e.g., local and/or remote). In this regard, such ‘control terminals’ may comprise systems or devices used to send control commands (e.g., by system operators) and/or to which control related data (as obtained in the headend 400) may be reported, and/or systems or devices used to obtain and/or provide control related data (e.g., in the distribution system/network) to the headend 400. Accordingly, the control information 431 may be used in management and/or configuration of the headend 400.

For example, the control and monitoring circuit 430 may be operable to perform measurements such as, e.g., measuring time domain and/or frequency domain characteristics of incoming and/or outgoing signals, reporting such measurements to a management entity, receiving commands and configuring one or more circuits of the headend 400 in response to such commands, and/or other control/management operations. Accordingly, the control and monitoring circuit 430 may enable remote management, configuration, and inspection rather than requiring on-site visits to and/or direct interactions with the headend (e.g., by field technicians).

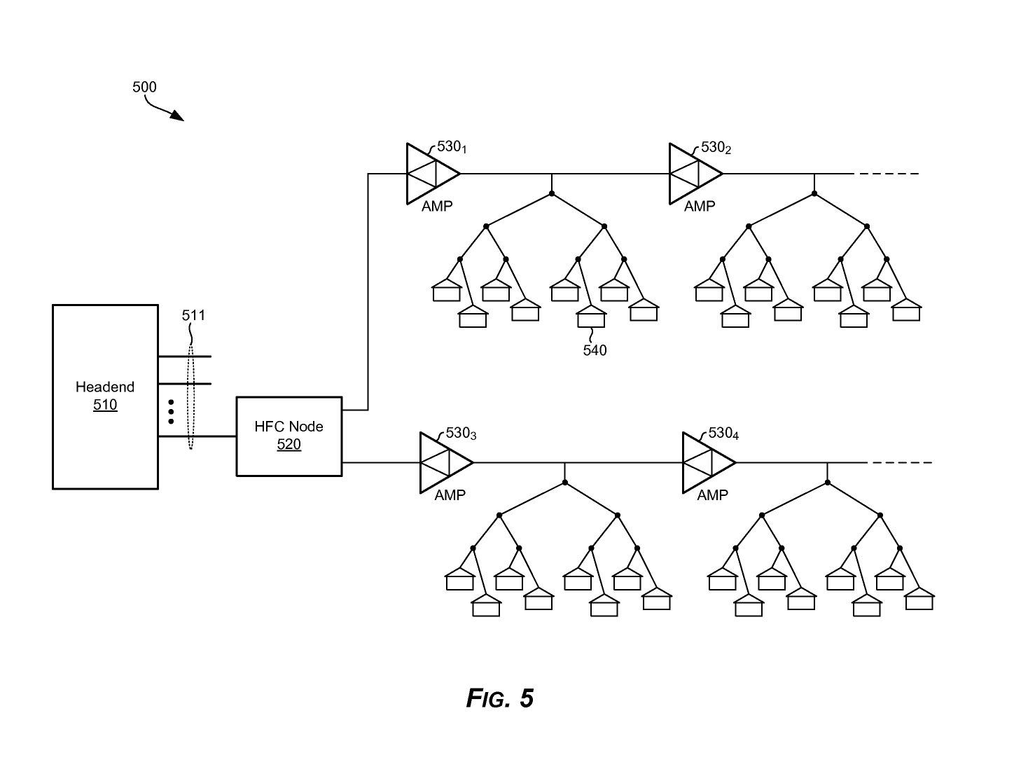

Further, in some implementations, the control and monitoring circuit 430 may receive feedback from client devices—e.g., customer premises equipment and/or monitoring circuitry installed in a distribution (e.g., HFC based) network, in which the headend 400 may be used. An example of use of such feedback by headends in such networks is described in more detail with reference to, for example, FIG. 5.

In an example implementation, the control and monitoring circuit 430 may be interfaced, using an application programming interface (API) as is set forth in one or more standards documents—e.g., standards pertaining to converged cable access platform (CCAP).

The digital processing circuit 420 may be operable to perform digital processing, such as of the digitized signals output by the feed front-end circuit 440. Such processing may include, for example, filtering, frequency translation, replication, leveling/equalization, pre-distortion/pre-emphasis, gain control, combining, multiplexing, and/or the like. In operation, the digital processing circuit 420 may receive one or more signals 411ᵢ and/or one or more signals 443ᵢ, digitally combine the signals, and output the combined signal to one or more of the DAC circuits 450 according to a service group mapping.

In an example implementation, one or more of the signals 443ᵢ may be filtered to remove or reduce out-of-band components prior to the combining to optimize SNR, dynamic range, noise floor levels, and/or some other characteristic of the resulting combined signal.

The processed (and, in some instances, filtered) combined signals may be converted to analog signals, via the DAC circuits 450 and then output to the signal modulators 460. In this regard, the signal modulators 460 may be operable to module the generate signals such that they may be communicated over used interface (in accordance with a used protocol). For example, signal modulators 460 may be laser modulators in HFC setups, configured for generating HFC (optic) based signals.

In an example implementation, the digital processing circuit 420 may be operable to perform channelization and/or frequency translation (i.e., “channel stacking” or “band stacking”) of one or more of the inputs 443ᵢ prior to combining.

In an example implementation, the digital processing circuit 420 may be operable to perform automatic leveling, equalization, and/or gain of the signals 443ᵢ and/or 411ᵢ prior to the combining. These signal adjustments may be to, for example, equalize the relative levels of the various signals 443ᵢ and/or 411ᵢ and/or to set the level of a signal resulting from the combination of two or more of signals 443ᵢ and/or 411ᵢ. The level(s) of the combined signal(s) may be set to prevent or at least reduce the impact of clipping in the laser modulators 460. For example, if it is determined that clipping is likely to occur in the laser modulator, the combined signal(s) may be artificially clipped in the digital processing circuit 420. This may be done because clipping performed in the digital processing circuit 420 may be more controlled and/or deterministic whereas clipping in the laser modulators 460 may have indeterminate results.

In an example implementation, the digital processing circuit 420 may have one or more output ports onto which one or more of the signals 443ᵢ, one or more of the signals 411ᵢ, and/or one or more combined signals are replicated. In this manner, multiple instances of the headend 400 and/or the digital processing circuit 420 may be daisy-chained. This may enable, for example, increased capacity, improved load balancing, etc.

In an example implementation, processing performed by the digital processing circuit 420 may be based on non-linearity, or other characteristics, of the laser modulators 460. For example, RF outputs may be pre-distorted to compensate for non-linearity of the laser modulators 460.

In an example implementation, the headend 400 may comprise one or more RF/analog outputs for compatibility with, for example, components of systems requiring such outputs, such as, for example, the headend architectures shown in FIGS. 1 and/or 2. For example, the headend may comprise an RF port driven by a power amplifier (PA) in a manner which could drive the RF/analog based combining networks 270 or 320.

Each of the digital-to-analog converter (DAC) circuits 450₁-450_{K} may drive its respective RF port, cable, and laser modulator 460. Because the combining is done digitally, rather than through an RF analog network, significantly less power may be needed to drive the RF outputs, and thus power amplifiers may not be needed for driving the laser modulators. In one implementation, the laser modulators 460, or a portion thereof, may be implemented on-chip and/or on-pcb (printed circuit board) with the digital processing circuit 420 and/or the DAC circuits 450, such that fiber optic cables may be directly connect to the headend 400 rather than requiring use of coaxial cables to connect to ‘external’ laser modulators as is shown in FIG. 4.

In an example implementation, the headend 400 may be operable to support daisy chain coupling to other headends. For example, the digital processing circuit 420 may be operable to generate a daisy chain data output 421, which may be conveyed to one or more other headends. The use of the daisy chain data output 421 may allow combining content (e.g., data and/or video) corresponding to a plurality of service groups using a plurality of headends (rather than just performing the combining in one headend—e.g., the headend 400).

FIG. 5 illustrates example cable network topology. Referring to FIG. 5, there is shown a topology 500, which may correspond to an example cable network distribution topology. As shown in FIG. 5, the topology 500 may be a HFC based topology.

The topology 500 may comprise a headend 510, connected to one or more distribution fiber (e.g., HFC) nodes 520, with each fiber node 520 connecting to plurality of user equipment (e.g., customer premise equipment (CPE), such as DOCSIS modems and/or television set-top boxes) residing in premises 540. Further, in some instances one or more bidirectional line amplifiers 530ᵢ (e.g., amplifiers 530₁-530₄) may be utilized, being placed in the connections between each fiber node 520 and the user equipment (in premises 540) coupled thereto. In this regard, the placement of the amplifiers 530ᵢ may be determined in adaptive manner (e.g., based on a determination of where application of amplification may be needed, such as based on distance and/or number of CPE(s) in each amplification stage).

The fiber node 520 may comprise suitable circuitry for converting signals between the headend 510 and the user equipment in premises 540. The fiber node 520 may convert, for example, optical signals to electrical signals in the downstream (from the headend 510), and may convert electrical signals to optical signals in the upstream (to the headend 510).

Each of the amplifiers 530ᵢ may comprise circuitry for providing amplification bidirectionally (i.e., in both directions—that is upstream and downstream). For example, each amplifier 530ᵢ may apply amplification gain to upstream and downstream signals between the fiber node 540 and the user equipment. In this regard, each of the amplifiers 530ᵢ may be configured to apply different amplification gain in the upstream and downstream direction.

In an example implementation, the topology 500 may be configured such that devices and/or systems downstream from the headends (e.g., the fiber node 520, one or more of the amplifiers 530ᵢ, and/or one or more of the user equipment in premises 540) may be implemented as ‘intelligent’ platforms, such as to enable monitoring and reporting (e.g., of control information) to the headends—e.g., monitoring upstream and/or downstream activities, reporting signal characteristics, etc. For example, the fiber node 520, one or more of the amplifiers 530ᵢ, and/or one or more of the user equipment in premises 540 may incorporate cable modem (or a reduced complexity/functionality cable modem) functions, with each cable modem function comprising a full-spectrum capture, for capturing and reporting frequency-domain snapshots of the HFC plant.

The headend 510 may comprise suitable circuitry for supporting headend operations and/or functions. In this regard, the headend 510 may be substantially similar to the headends (or headend architectures) described with reference to FIGS. 2, 3, and/or 4. Accordingly, the headend 510 may support several heterogeneous services (e.g., DOCSIS, VOD, SDV, OOB, broadcast analog and/or digital television based services, and the like) and may be operable to generate downstream signals combining content (e.g., video or other data) from the different supported services, for communication over HFC based distribution network to end-user equipment (e.g., like those in the premises 540).

In an example implementation, the headend 510 may be configured to incorporate use of control information in processing signals, particularly downstream signals, as described with reference to FIG. 4, for example. In this regard, control information obtained from devices and systems downstream from the headend 510 (i.e., downstream feedback) may be used in managing and adjusting operations of the headend 510. For example, feedback from circuitry in the fiber node 520, in one or more of the amplifiers 530ᵢ, and/or in one or more of the user equipment in premises 540 may be used to control and/or adjust the processing performed in the headend 510 (e.g., pre-distortion, frequency translation, combining, filtering, etc.). Enabling adaptive processing in this manner (i.e., based on downstream feedback) may be desirable as it may enable operators to better utilize the network (e.g., “buying” some additional link margin) prior to having to upgrade infrastructure.

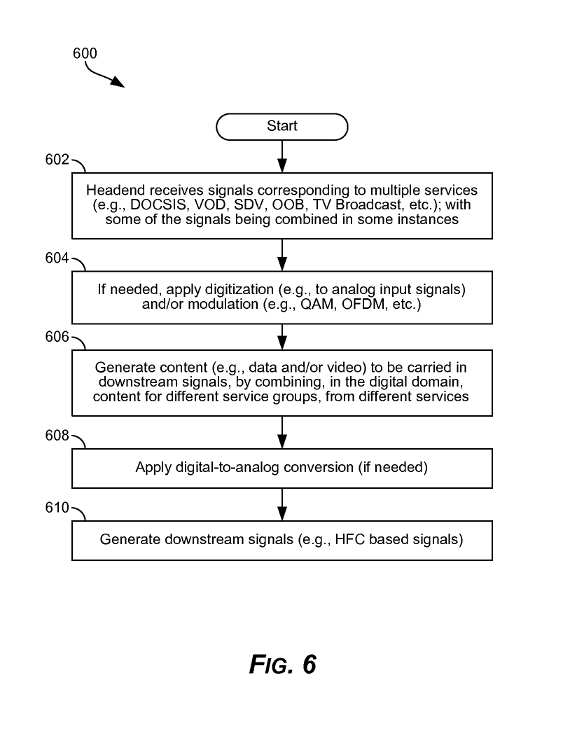

FIG. 6 is a flowchart illustrating an example process for combining content from different services into multiple service groups for downstream distribution. Referring to FIG. 6, there is shown a flow chart 600, comprising a plurality of example steps, which may be executed in a headend (e.g., the headend 400 of FIG. 4) that may be used in cable distribution networks.

In step 602, the headend may receive signals corresponding to multiple services (e.g., DOCSIS, VOD, SDV, OOB, TV Broadcast, etc.); with some of the signals being combined into combined feed (e.g., feed 301) in some instances.

In step 604, the headend may apply digitization (e.g., to analog input signals) and/or modulation (e.g., QAM, OFDM, etc.), if needed. For example, the feed front-end circuit 440 may be used to digitize (analog) feed signals 441ᵢ; whereas the modulation circuit 410 may be used to apply modulation (e.g., QAM, OFDM, etc.) to data obtained from signals received over network interface.

In step 606, the headend may generate content (e.g., data and/or video) to be carried in downstream signals, by combining, in the digital domain, content for different service groups, from the different services.

In step 608, the headend may apply digital-to-analog conversions (if needed). For example, the DAC circuits 450i may be used to generate analog/RF outputs, which may be used in the combining network 460.

In step 610, downstream signals may be generated. For example, laser modulators in the combining network 460 may be used to generate HFC signals, for use in downstream distribution.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for non-intrusive noise cancelation.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method, comprising:
generating in a headend, one or more downstream signals for communication in a distribution network associated with the headend, wherein:
the generating comprises combining data and/or video from signals corresponding to a plurality of services supported by the headend into the one or more downstream signals,
the combining is performed based on one or more data and/or video service groups associated with each of the one or more downstream signals, with each service group corresponding to particular data and/or video provided by one or more of the plurality of services, and
the combining is performed in digital domain.

2. The method of claim 1, wherein the distribution network comprises a cable distribution network.

3. The method of claim 2, wherein the cable distribution network is a hybrid fiber-coaxial (HFC) based network.

4. The method of claim 1, wherein the plurality of services comprises cable television based services, video on demand (VOD) based services, switched digital video (SDV) based services, out-of-band control signals (OOB) based services, and/or broadcast television based services.

5. The method of claim 1, comprising controlling the combining based on control feedback received from the distribution network.

6. The method of claim 1, comprising receiving upstream signals from one or more downstream devices in the distribution network, the upstream signals comprising control feedback relating to the downstream signals communicated by the headend.

7. The method of claim 5, wherein the one or more downstream devices comprise fiber nodes and/or user equipment.

8. A system, comprising:
one or more circuits for use in an headend, the one or more circuits being operable to generate one or more downstream signals for communication in a distribution network associated with the headend, wherein:
the generating comprises combining data and/or video from signals corresponding to a plurality of services,
the combining is performed based on one or more data and/or video service groups associated with each of the one or more downstream signals, with each service group corresponding to particular data and/or video provided by one or more of the plurality of services, and
the combining is performed in digital domain.

9. The system of claim 8, wherein the distribution network comprises a cable distribution network.

10. The system of claim 9, wherein the cable distribution network is a hybrid fiber-coaxial (HFC) based network.

11. The method of claim 1, wherein the plurality of services comprises cable television based services, video on demand (VOD) based services, switched digital video (SDV) based services, out-of-band control signals (OOB) based services, and/or broadcast television based services.

12. The system of claim 8, wherein the one or more circuits are operable to control the combining based on control feedback received from the distribution network.

13. The system of claim 8, wherein the one or more circuits are operable to receive upstream signals from one or more downstream devices in the distribution network, the upstream signals comprising control feedback relating to the downstream signals communicated by the headend.

14. The system of claim 13, wherein the one or more downstream devices comprise fiber nodes and/or user equipment.

15. A system, comprising:
one or more circuits for use in an headend that is configured to support distribution of signals corresponding to a plurality of supported services within a distribution network associated with the headend, the one or more circuits comprising:
a modulation circuit that is operable to apply modulation and/or demodulation based on at least one of the plurality of services; and
a digital processing circuit that is operable to perform digital processing of one or more downstream signals generated in the headend for communication in the distribution network, wherein:
the digital processing comprising combining data and/or video from one or more of the signals corresponding to the plurality of supported services, and
the combining is performed, in the digital domain, based on one or more data and/or video service groups associated with each of the one or more downstream signals, with each service group corresponding to particular data and/or video provided by one or more of the plurality of services.

16. The method of claim 1, wherein the plurality of services comprises cable television based services, video on demand (VOD) based services, switched digital video (SDV) based services, out-of-band control signals (OOB) based services, and/or broadcast television based services.

17. The system of claim 15, wherein the one or more circuits comprise a feed front-end circuit that is operable to receive one or more feeds corresponding to one or more of the plurality of supported services.

18. The system of claim 17, wherein the feed front-end circuit comprises one or more analog-to-digital converter (ADC) circuits, for converting analog inputs corresponding to the one or more feeds into corresponding one or more digital outputs, for conveyance to the digital processing circuit.

19. The system of claim 18, wherein the one or more digital outputs are conveyed to the digital processing circuit, for combining within the generated downstream signals.

20. The system of claim 15, wherein the one or more circuits comprising a control and monitoring circuit that is operate to control and/or monitor the combining performed in the digital processing circuit.

21. The system of claim 20, wherein the control and monitoring circuit is operable to control the combining performed in the digital processing circuit based on control feedback received from the distribution network.

22. The system of claim 20, wherein the control and monitoring circuit is operable to receive upstream signals from one or more downstream devices in the distribution network, the upstream signals comprising control feedback relating to the downstream signals communicated by the headend.
